(19) United States
(12) Patent Application Publication
(10) Pub. No.: US 2014/0341283 A1
(43) Pub. Date: Nov. 20, 2014

(54) METHOD AND APPARATUS FOR ENCODING VIDEO AND METHOD AND APPARATUS FOR DECODING VIDEO CHANGING SCANNING ORDER DEPENDING ON HIERARCHICAL CODING UNIT

(71) Applicant: SAMSUNG ELECTRONICS CO., LTD., Suwon-si (KR)

(72) Inventors: Jong-bum CHOI, Suwon-si (KR); Jae-Hyun KIM, Seoul (KR); Kyo-hyuk LEE, Yongin-si (KR)

(73) Assignee: SAMSUNG ELECTRONICS CO., LTD., Suwon-si (KR)

(21) Appl. No.: 14/336,493

(22) Filed: Jul. 21, 2014

Related U.S. Application Data
(63) Continuation of application No. PCT/KR2013/000488, filed on Jan. 21, 2013.
(60) Provisional application No. 61/588,624, filed on Jan. 19, 2012.

(51) Int. Cl. H04N 19/129; H04N 19/51

(52) U.S. Cl. CPC H04N 19/00109; H04N 19/00587
USPC 375/240.12

(57) ABSTRACT

A method and apparatus for encoding a video and a method and apparatus for decoding a video which change a scanning order according to hierarchical coding units.

### CROSS-REFERENCE TO RELATED PATENT APPLICATION

The present application is a continuation application of International Application No. PCT/KR2013/000488, filed on Jan. 21, 2013, and claims the benefit of U.S. Provisional Application No. 61/588,624, filed on Jan. 19, 2012, in the U.S. Patent and Trademark Office, the disclosures of which are incorporated herein by reference in their entireties.

### 1. FIELD

Methods and apparatuses consistent with exemplary embodiments relate to video encoding and decoding.

### 2. DESCRIPTION OF RELATED ART

As hardware capable of reproducing and storing high-resolution or high-quality video content has been developed and distributed, the need for a video codec capable of effectively encoding or decoding high-resolution or high-quality video content has increased. An existing video codec encodes a video according to a limited encoding method based on a macroblock having a predetermined size. Also, the existing video codec encodes or decodes video data by raster-scanning the macroblock.

### SUMMARY

According to an aspect of an exemplary embodiment, there is provided a method of encoding a video, the method including: splitting a picture into maximum coding units having a maximum size; determining a processing order of the maximum coding units from among a plurality of different processing orders, based on a size of the maximum coding units; splitting each of the maximum coding units into coding units having a hierarchical structure according to the determined processing order and encoding the coding units; and outputting size information of each of the maximum coding units and outputting encoded data of each of the maximum coding units.

According to another aspect of an exemplary embodiment, there is provided a method of encoding a video, the method including: splitting a picture into maximum coding units having a maximum size; splitting each of the maximum coding units into coding units having a size that is equal to or less than a size of the maximum coding units and equal to or greater than a size of a minimum coding unit; processing the maximum coding units according to a first processing order, and performing prediction encoding on the coding units split from the maximum coding units according to a second processing order that is different from the first processing order; and outputting size information of each of the maximum coding units, size information of the minimum coding unit, and size information of each of the coding units.

According to another aspect of an exemplary embodiment, there is provided an apparatus for encoding a video, the apparatus including: a maximum coding unit splitter that splits a picture into maximum coding units having a maximum size; a coded depth determiner that determines a processing order of the maximum coding units from among a plurality of different processing orders based on a size of the maximum coding units, splits each of the maximum coding units into coding units having a hierarchical structure according to the determined processing order, and encodes the coding units; and an output unit that outputs size information of each of the maximum coding units and encoded data of each of the maximum coding units.

According to another aspect of an exemplary embodiment, there is provided an apparatus for encoding a video, the apparatus including: a maximum coding unit splitter that splits a picture into maximum coding units having a maximum size; a coded depth determiner that splits each of the maximum coding units into coding units having a size that is equal to or less than a size of the maximum coding units and equal to or greater than a size of a minimum coding unit, processes the maximum coding units according to a first processing order, and performs prediction encoding on the coding units split from the maximum coding units according to a second processing order that is different from the first processing order; and an output unit that outputs size information of each of the maximum coding units, size information of the minimum coding unit, and size information of each of the coding units.

According to another aspect of an exemplary embodiment, there is provided a method of decoding a video, the method including: obtaining size information of each of maximum coding units that are decoded from a bitstream, split information of coding units having a hierarchical structure split from the maximum coding units, and encoded data of the coding units; determining a processing order of the maximum coding units from among a plurality of different processing orders based on a size of the maximum coding units; and decoding the coding units that are split from the maximum coding units according to the determined processing order.

According to another aspect of an exemplary embodiment, there is provided a method of decoding a video, the method including: obtaining size information of each of maximum coding units that are decoded from a bitstream, size information of each of coding units split from the maximum coding units, size information of a minimum coding unit, and encoded data of the coding units; and processing the maximum coding units according to a first processing order, and performing prediction decoding on the coding units included in each of the maximum coding units according to a second processing order that is different from the first processing order.

According to another aspect of an exemplary embodiment, there is provided an apparatus for decoding a video, the apparatus including: an extractor that obtains size information of each of maximum coding units that are decoded from a bitstream, split information of coding units having a hierarchical structure split from the maximum coding units, and encoded data of the coding units; and an image data decoder that determines a processing order of the maximum coding units from among a plurality of different processing orders based on a size of the maximum coding units, and decodes the coding units split from the maximum coding units according to the determined processing order.

According to another aspect of an exemplary embodiment, there is provided an apparatus for decoding a video, the apparatus including: an extractor that obtains size information of each of maximum coding units that are decoded from a bitstream, size information of coding units split from each of the maximum coding units, size information of a minimum coding unit, and encoded data of the coding units; and an image data decoder that processes the maximum coding units according to a first processing order, and performs prediction decoding on the coding units included in each of the maximum coding units according to a second processing order that is different from the first processing order.

One or more exemplary embodiments provide a processing order of maximum coding units to more effectively use, in a codec that supports maximum coding units having various sizes, neighboring information according to the various sizes of the maximum coding units.

Also, one or more exemplary embodiments provide a processing order of coding units independent from maximum coding units to effectively use neighboring information when the coding units having a size that is less than a usable size of the maximum coding units are encoded.

According to one or more exemplary embodiments, a suitable scanning order is selected in consideration of a size of a data unit.

According to one or more exemplary embodiments, encoding efficiency may be improved since, when a maximum coding unit having a small size is encoded, a correlation between the maximum coding unit and a neighboring pixel may be more efficiently used.

### BRIEF DESCRIPTION OF THE DRAWINGS

FIG. 1 is a block diagram of a video encoding apparatus according to an exemplary embodiment.

FIG. 2 is a block diagram of a video decoding apparatus according to an exemplary embodiment.

FIG. 3 is a diagram for describing a concept of coding units according to an exemplary embodiment;

FIG. 4 is a block diagram of an image encoder, according to an exemplary embodiment;

FIG. 5 is a block diagram of an image decoder, according to an exemplary embodiment;

FIG. 6 is a diagram illustrating deeper coding units according to depths and prediction units, according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths according to an exemplary embodiment;

FIGS. 10 through 12 are diagrams for describing a relationship between coding units, prediction units, and frequency transformation units, according to an exemplary embodiment;

FIG. 13 is a diagram for describing a relationship between a coding unit, a prediction unit, and a transformation unit, according to the encoding mode information, according to an exemplary embodiment.

FIG. 14 is a flowchart illustrating a method of encoding a video, according to an exemplary embodiment.

FIGS. 15A through 17 are diagrams for describing a processing order of maximum coding units according to a size of each of the maximum coding units, according to an exemplary embodiment.

FIG. 18 is a flowchart illustrating a method of encoding a video, according to another exemplary embodiment.

FIGS. 19A and 19B are diagrams for describing a relationship between a maximum coding unit and a coding unit, according to another exemplary embodiment.

FIGS. 20 and 21 are diagrams for describing a processing order of maximum coding units and coding units that are included in each of the maximum coding units according to a size of the coding units split from a size of each of the maximum coding units, according to an exemplary embodiment.

FIGS. 22 and 23 are diagrams illustrating size information of a maximum coding unit, size information of a minimum coding unit, and size information of a coding unit added to a sequence parameter set (SPS), according to another exemplary embodiment.

FIG. 24 is a flowchart illustrating a method of decoding a video, according to an exemplary embodiment.

FIG. 25 is a flowchart illustrating a method of decoding a video, according to another exemplary embodiment.

### DETAILED DESCRIPTION OF EXEMPLARY EMBODIMENTS

Exemplary embodiments will now be described more fully with reference to the accompanying drawings, in which the exemplary embodiments are shown.

FIG. 1 is a block diagram of a video encoding apparatus 100 according to an exemplary embodiment.

The video encoding apparatus 100 includes a maximum coding unit splitter 110, a coding unit determiner 120, and an output unit 130.

The maximum coding unit splitter 110 may split a current picture based on a maximum coding unit that is a coding unit having a maximum size for the current picture of an image. If the current picture is larger than the maximum coding unit, image data of the current picture may be split into the at least one maximum coding unit. The maximum coding unit may be a data unit having a size of 32×32, 64×64, 128×128, or 256×256, wherein a shape of the data unit is a square having a width and length 2ⁿ. The image data may be output to the coding unit determiner 120 according to the at least one maximum coding unit.

A coding unit may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Because a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Because the maximum coding unit is split according to depths, the image data of a spatial domain included in the maximum coding unit may be hierarchically classified according to depths.

A maximum depth and a maximum size of a coding unit, which limit a total number of times a height and a width of the maximum coding unit are hierarchically split, may be previously set.

The coding unit determiner 120 encodes at least one split region obtained by splitting a region of the maximum coding unit according to depths, and determines a depth to output final encoding results according to the at least one split region. In other words, the coding unit determiner 120 determines a coded depth by encoding the image data in the deeper coding units according to depths, according to the maximum coding unit of the current picture, and selecting a depth having a smallest encoding error. The determined coded depth and the image data according to the maximum coding unit are output.

The image data in the maximum coding unit is encoded based on the deeper coding units corresponding to at least one depth equal to or less than the maximum depth, and encoding results are compared based on each of the deeper coding units. A depth having the smallest encoding error may be selected after comparing encoding errors of the deeper coding units. At least one coded depth may be selected for each maximum coding unit.

A size of the maximum coding unit is split as a coding unit is hierarchically split according to depths, and a number of coding units increases. Also, even if coding units correspond to the same depth in one maximum coding unit, it is determined whether to split each of the coding units corresponding to the same depth to a lower depth by measuring an encoding error of the data of each coding unit, separately. Accordingly, even when data is included in one maximum coding unit, the encoding errors according to depths may differ according to regions, and thus the coded depths may differ according to regions. Thus, one or more coded depths may be set for one maximum coding unit, and the data of the maximum coding unit may be divided according to coding units of the one or more coded depths.

Accordingly, the coding unit determiner 120 may determine coding units having a tree structure included in a current maximum coding unit. The ‘coding units having a tree structure’ according to an exemplary embodiment include coding units corresponding to a depth determined to be a coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth is an index related to a number of times splitting is performed from a maximum coding unit to a minimum coding unit. A first maximum depth may denote a total number of times splitting is performed from the maximum coding unit to the minimum coding unit. A second maximum depth may denote a total number of depth levels from the maximum coding unit to the minimum coding unit. For example, when a depth of the maximum coding unit is 0, a depth of a coding unit in which the maximum coding unit is split once may be set to 1, and a depth of a coding unit in which the maximum coding unit is split twice may be set to 2. In this case, if the minimum coding unit is a coding unit obtained by splitting the maximum coding unit four times, 5 depth levels of depths 0, 1, 2, 3 and 4 exist, and thus the first maximum depth may be set to 4 and the second maximum depth may be set to 5.

Prediction encoding and frequency transformation may be performed according to the maximum coding unit. The prediction encoding and the frequency transformation are also performed based on the deeper coding units according to a depth equal to or depths less than the maximum depth, according to the maximum coding unit.

Because a number of deeper coding units increases whenever the maximum coding unit is split according to depths, encoding including the prediction encoding and the frequency transformation is performed on all of the deeper coding units generated as the depth increases. For convenience of description, the prediction encoding and the frequency transformation will now be described based on a coding unit of a current depth, from among at least one maximum coding unit.

The video encoding apparatus 100 may variously select a size or shape of a data unit for encoding the image data. In order to encode the image data, operations, such as prediction encoding, frequency transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit.

For example, when a coding unit of 2N×2N (where N is a positive integer) is no longer split, the coding unit may become a prediction unit of 2N×2N and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a smallest encoding error.

The video encoding apparatus 100 may also perform the frequency transformation on the image data in a coding unit based on, not only the coding unit for encoding the image data, but also based on a data unit that is different from the coding unit.

In order to perform the frequency transformation in the coding unit, the frequency transformation may be performed based on a data unit having a size smaller than or equal to a size of the coding unit. For example, the data unit for the frequency transformation may include a data unit for an intra mode and a data unit for an inter mode.

A data unit used as a base of the frequency transformation will now be referred to as a ‘transformation unit’. Similar to the coding unit, the transformation unit in the coding unit may be recursively split into smaller sized transformation units, and thus, residual data in the coding unit may be divided according to the transformation unit having a tree structure according to transformation depths.

A transformation depth indicating a number of times splitting is performed to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of a transformation unit is N×N, and may be 2 when the size of a transformation unit is N/2×N/2. That is, the transformation unit having the tree structure may also be set according to transformation depths.

Encoding information according to coding units corresponding to a coded depth requires not only information about the coded depth but also about information related to prediction encoding and frequency transformation. Accordingly, the coding unit determiner 120 not only determines a coded depth having a smallest encoding error, but also determines a partition type in a prediction unit, a prediction mode according to prediction units, and a size of a transformation unit for frequency transformation.

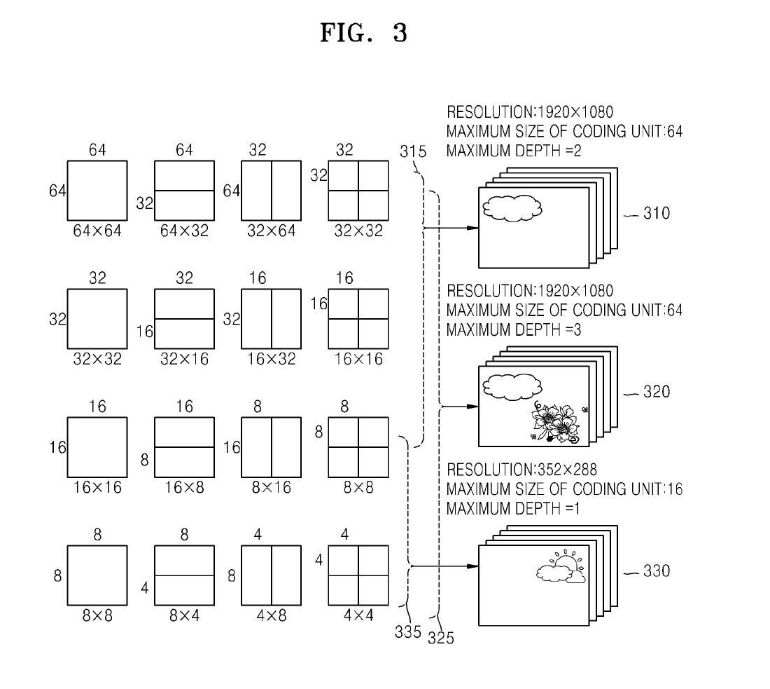

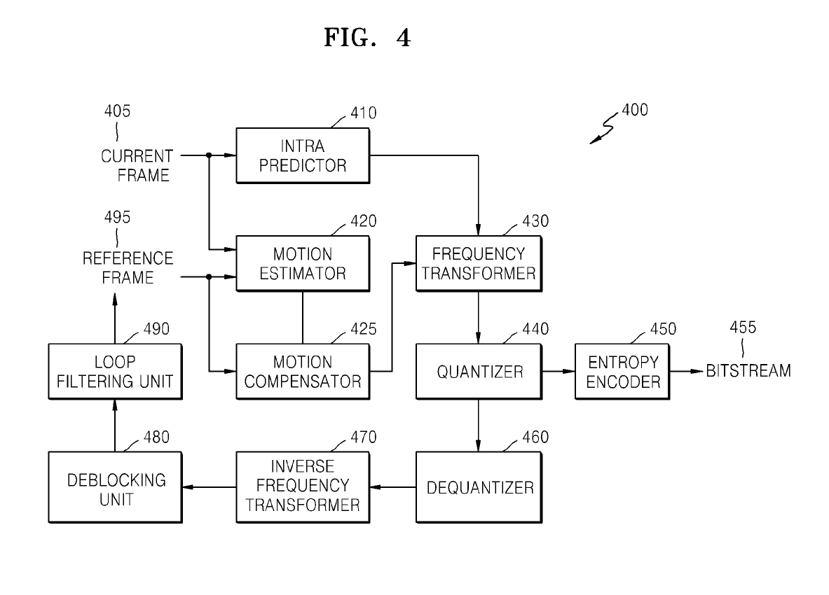

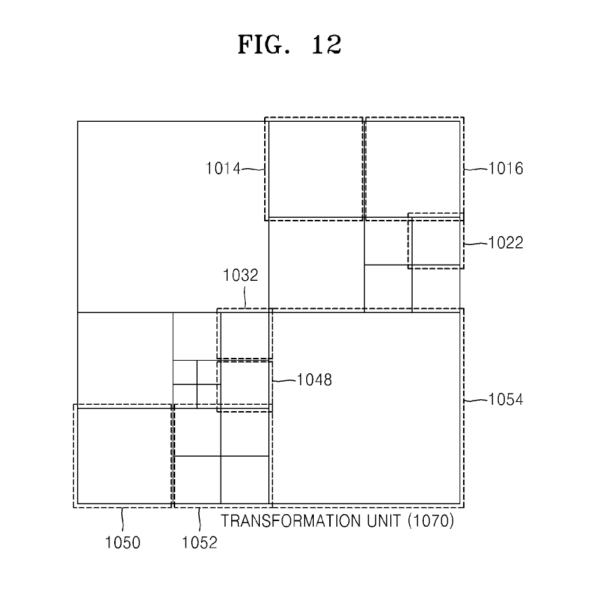

Coding units having a tree structure in a maximum coding unit and a method of determining a partition will be described in detail later with reference to FIGS. 3 through 12.

The coding unit determiner 120 may measure an encoding error of deeper coding units according to depths by using Rate-Distortion (RD) Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, the encoding is performed on the current coding unit of the current depth, and thus the split information may indicate not to split the current coding unit to a lower depth. Alternatively, if the current depth of the current coding unit is not the coded depth, the encoding is performed on the coding unit of the lower depth, and thus the split information may indicate to split the current coding unit to obtain the coding units of the lower depth.

If the current depth is not the coded depth, encoding is performed on the coding unit that is split into the coding unit of the lower depth. Because at least one coding unit of the lower depth exists in one coding unit of the current depth, the encoding is repeatedly performed on each coding unit of the lower depth, and thus the encoding may be recursively performed for the coding units having the same depth.

Because the coding units having a tree structure are determined for one maximum coding unit and information about at least one encoding mode is determined for a coding unit of a coded depth, information about at least one encoding mode may be determined for one maximum coding unit. Also, a coded depth of the data of the maximum coding unit may be different according to locations because the data is hierarchically split according to depths, and thus information about the coded depth and the encoding mode may be set for the data.

Accordingly, the output unit 130 may assign encoding information about a corresponding coded depth and an encoding mode to at least one of the coding unit, the prediction unit, and a minimum coding unit included in the maximum coding unit.

The minimum coding unit is a rectangular data unit obtained by splitting the minimum coding unit constituting a lowermost depth by 4. Alternatively, the minimum coding unit may be a maximum rectangular data unit that may be included in all of the coding units, prediction units, partition units, and transformation units included in the maximum coding unit.

For example, the encoding information output through the output unit 130 may be classified into encoding information according to deeper coding units according to depths, and encoding information according to prediction units. The encoding information according to the deeper coding units according to depths may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Also, information about a maximum size of the coding unit defined according to pictures, slices, or GOPs, and information about a maximum depth may be inserted into a header of a bitstream.

In the video encoding apparatus 100, the deeper coding unit is a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of 4 coding units of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, because encoding may be performed on each maximum coding unit by using any one of various prediction modes and frequency transformations, an optimum encoding mode may be determined considering image characteristics of the coding unit of various image sizes.

Thus, if an image having high resolution or a large data amount is encoded in a conventional macroblock, a number of macroblocks per picture excessively increases. Accordingly, a number of pieces of compressed information generated for each macroblock increases, and thus it is difficult to transmit the compressed information, and data compression efficiency decreases. However, by using the video encoding apparatus 100, image compression efficiency may be increased because a coding unit is adjusted while considering characteristics of an image while increasing a maximum size of a coding unit while considering a size of the image.

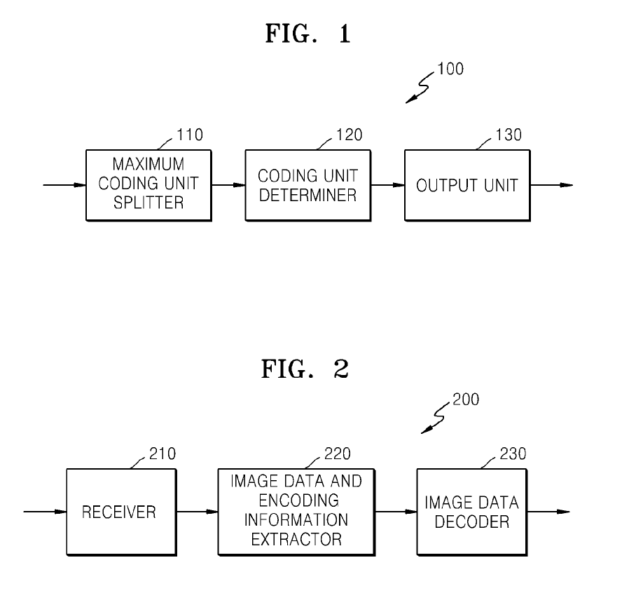

FIG. 2 is a block diagram of a video decoding apparatus 200 according to an exemplary embodiment.

The video decoding apparatus 200 includes a receiver 210, an image data and encoding information extractor 220, and an image data decoder 230. Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having the tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coded depth, and information about an encoding mode according to each coded depth may include information about a partition type of a corresponding coding unit corresponding to the coded depth, a prediction mode, and a size of a transformation unit. Also, split information according to depths may be extracted as the information about the coded depth.

The information about the coded depth and the encoding mode according to each maximum coding unit extracted by the image data and encoding information extractor 220 is information about a coded depth and an encoding mode determined to generate a smallest encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to an encoding mode that generates the smallest encoding error.

Because encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. When the information about the coded depth of the corresponding maximum coding unit and the encoding mode is recorded according to the predetermined data units, the predetermined data units having the same information about the coded depth and the encoding mode may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse frequency transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse frequency transformation according to each transformation unit in the coding unit, based on the information about the size of the transformation unit of the coding unit according to coded depths, to perform the inverse frequency transformation according to maximum coding units.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data of the current depth by using the information about the partition type of the prediction unit, the prediction mode, and the size of the transformation unit for image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain information about a coding unit that generates the least encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored according to a size of a coding unit and an encoding mode, which are adaptively determined according to characteristics of an image, by using information about an optimum encoding mode received from an encoder.

A method of determining coding units having a tree structure, a prediction unit, and a transformation unit according to an exemplary embodiment will now be described with reference to FIGS. 3 through 13.

FIG. 3 is a diagram for describing a concept of hierarchical coding units according to an exemplary embodiment.

A size of a coding unit may be expressed in width×height, and examples of the size of the coding unit may include 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is set to 1920×1080, a maximum size of a coding unit is set to 64, and a maximum depth is set to 2. In video data 320, a resolution is set to 1920×1080, a maximum size of a coding unit is set to 64, and a maximum depth is set to 3. In video data 330, a resolution is set to 352×288, a maximum size of a coding unit is set to 16, and a maximum depth is set to 1. The maximum depth shown in FIG. 3 denotes a total number of splits from a maximum coding unit to a minimum coding unit.

If a resolution is high or a data amount is large, a maximum size of a coding unit may be large to not only increase encoding efficiency, but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 because depths are increased to two layers by splitting the maximum coding unit twice. Meanwhile, because the maximum depth of the video data 330 is 1, coding units 335 of the video data 330 may include a maximum coding unit having a long axis size of 16, and coding units having a long axis size of 8 because depths are increased to one layer by splitting the maximum coding unit once.

Because the maximum depth of the video data 320 is 3, coding units 325 of the video data 320 may include a maximum coding unit having a long axis size of 64, and coding units having long axis sizes of 32, 16, and 8 because the depths are increased to 3 layers by splitting the maximum coding unit three times. As a depth increases, detailed information may be more precisely expressed.

FIG. 4 is a block diagram of an image encoder, according to an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 perform inter estimation and motion compensation on coding units in an inter mode from among the current frame 405 by using the current frame 405 and a reference frame 495.

Data output from the intra predictor 410, the motion estimator 420, and the motion compensator 425 is output as a quantized transformation coefficient through a frequency transformer 430 and a quantizer 440. The quantized transformation coefficient is restored as data in a spatial domain through an inverse quantizer 460 and an inverse frequency transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the frequency transformer 430, the quantizer 440, the entropy encoder 450, the inverse quantizer 460, the inverse frequency transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determine partitions and a prediction mode of each coding unit from among the coding units having the tree structure while considering the maximum size and the maximum depth of a current maximum coding unit, and the frequency transformer 430 determines the size of the transformation unit in each coding unit from among the coding units having the tree structure.

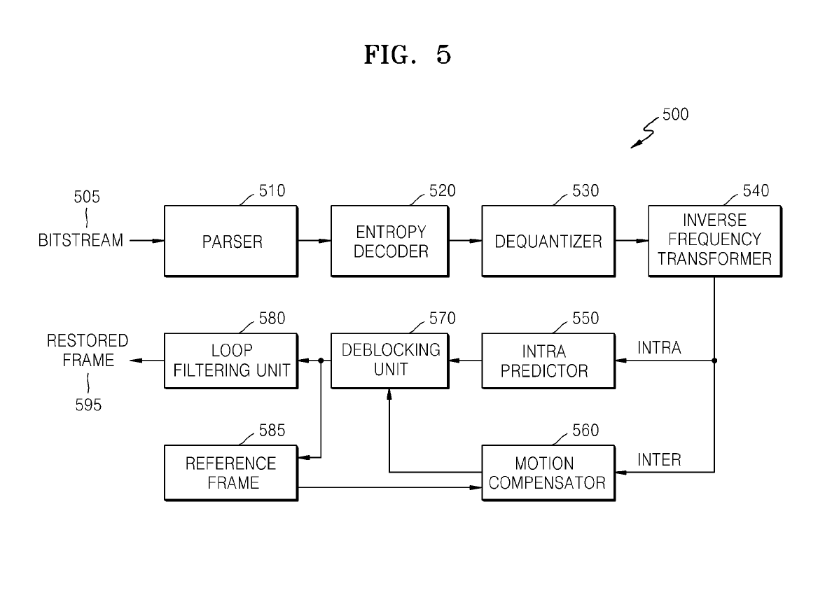

FIG. 5 is a block diagram of an image decoder, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse frequency transformer 540.

An intra predictor 550 performs intra prediction on coding units in an intra mode with respect to the image data in the spatial domain, and a motion compensator 560 performs motion compensation on coding units in an inter mode by using a reference frame 585.

The data in the spatial domain, which passed through the intra predictor 550 and the motion compensator 560, may be output as a restored frame 595 after being post-processed through a deblocking unit 570 and a loop filtering unit 580. Also, the data, which is post-processed through the deblocking unit 570 and the loop filtering unit 580, may be output as the reference frame 585.

In order to decode the image data in the image data decoder 230 of the video decoding apparatus 200, the image decoder 500 may perform operations that are performed after operations of the parser 510 are performed.

In order for the image decoder 500 to be applied in the video decoding apparatus 200, all elements of the image decoder 500, i.e., the parser 510, the entropy decoder 520, the inverse quantizer 530, the inverse frequency transformer 540, the intra predictor 550, the motion compensator 560, the deblocking unit 570, and the loop filtering unit 580 perform operations based on coding units having a tree structure for each maximum coding unit.

Specifically, the intra predictor 550 and the motion compensator 560 determine partitions and a prediction mode for each of the coding units having the tree structure, and the inverse frequency transformer 540 determines a size of a transformation unit for each coding unit.

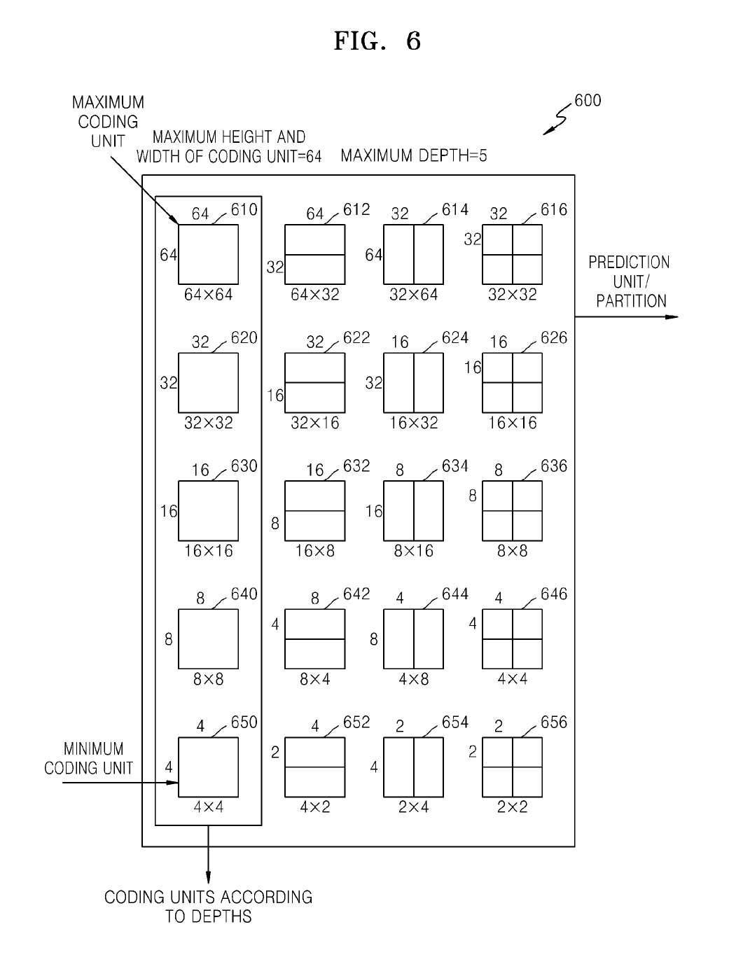

FIG. 6 is a diagram illustrating deeper coding units according to depths and partitions, according to an exemplary embodiment.

The video encoding apparatus 100 and the video decoding apparatus 200 use hierarchical coding units to consider characteristics of an image. A maximum height, a maximum width, and a maximum depth of coding units may be adaptively determined according to the characteristics of the image, or may be differently set by a user. Sizes of deeper coding units according to depths may be determined according to the maximum size of the coding unit which is previously set.

In a hierarchical structure 600 of coding units, the maximum height and the maximum width of the coding units are each 64, and the maximum depth is 4. Because a depth increases along a vertical axis of the hierarchical structure 600 of the coding units according to an embodiment, a height and a width of the deeper coding unit are each split. Also, a prediction unit and partitions, which are bases for prediction encoding of each deeper coding unit, are shown along a horizontal axis of the hierarchical structure 600 of the coding units.

In other words, a coding unit 610 is a maximum coding unit in the hierarchical structure 600 of the coding units, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the coding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

Finally, the coding unit 650 having the size of 4×4 and the depth of 4 is the minimum coding unit and a coding unit of a lowermost depth. A prediction unit of the coding unit 650 is only assigned to a partition having a size of 4×4.

In order to determine a coded depth of the maximum coding unit 610, the coding unit determiner 120 of the video encoding apparatus 100 perform encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are encoded.

In order to perform encoding according to each depth, a representative encoding error that is a smallest encoding error in the corresponding depth may be selected by performing encoding for each prediction unit in the deeper coding units, along the horizontal axis of the hierarchical structure 600 of the coding units. Alternatively, the smallest encoding error may be searched for by comparing representative encoding errors according to depths by performing encoding for each depth as the depth increases along the vertical axis of the hierarchical structure 600 of the coding units. A depth and a partition having the smallest encoding error in the maximum coding unit 610 may be selected as the coded depth and a partition type of the maximum coding unit 610.

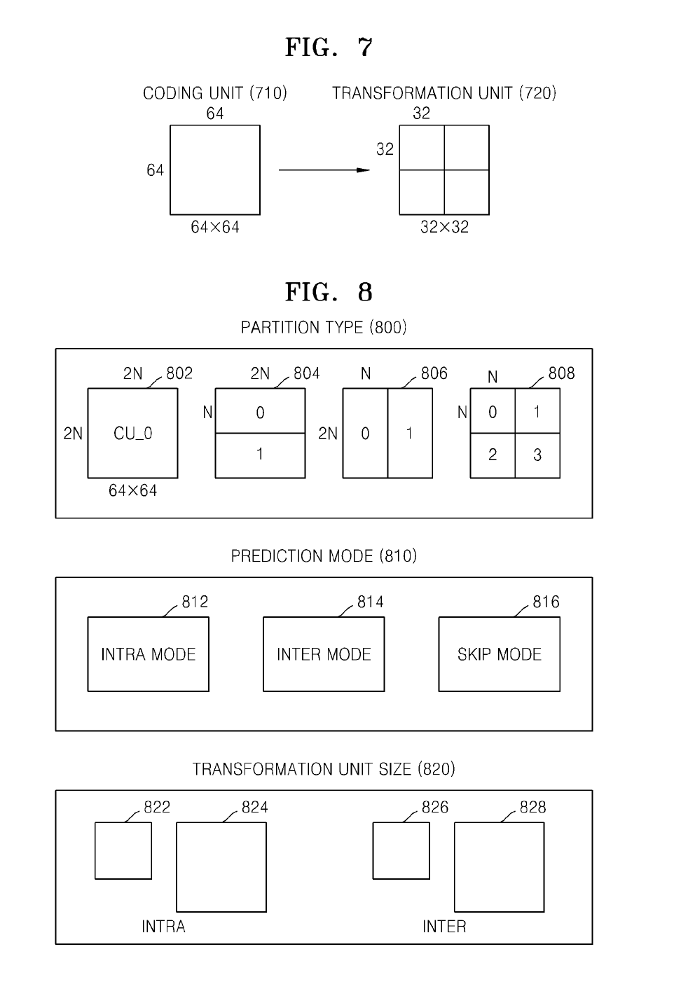

FIG. 7 is a diagram for describing a relationship between a coding unit and transformation units, according to an exemplary embodiment.

The video encoding apparatus 100 or the video decoding apparatus 200 encodes or decodes an image according to coding units having sizes smaller than or equal to a maximum coding unit for each maximum coding unit. Sizes of transformation units for frequency transformation during encoding may be selected based on data units that are not larger than a corresponding coding unit.

For example, in the video encoding apparatus 100 or the video decoding apparatus 200, if a size of the current coding unit 710 is 64×64, frequency transformation may be performed by using the transformation units 720 having a size of 32×32.

Also, data of the coding unit 710 having the size of 64×64 may be encoded by performing the frequency transformation on each of the transformation units having the size of 32×32, 16×16, 8×8, and 4×4, which are smaller than 64×64, and then a transformation unit having a smallest error may be selected.

FIG. 8 is a diagram for describing encoding information of coding units corresponding to a coded depth, according to an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 about the partition type indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type of the current coding unit is set to indicate one of the partition 804 having a size of 2N×N, the partition 806 having a size of N×2N, and the partition 808 having a size of N×N

The information 810 about the prediction mode indicates a prediction mode of each partition. For example, the information 810 about the prediction mode may indicate a mode of prediction encoding performed on a partition indicated by the information 800, i.e., an intra mode 812, an inter mode 814, or a skip mode 816.

Also, the information 820 about the size of the transformation unit indicates a transformation unit to be based on when frequency transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800 about the partition type, the information 810 about the prediction mode, and the information 820 about the size of the transformation unit for decoding according to each deeper coding unit

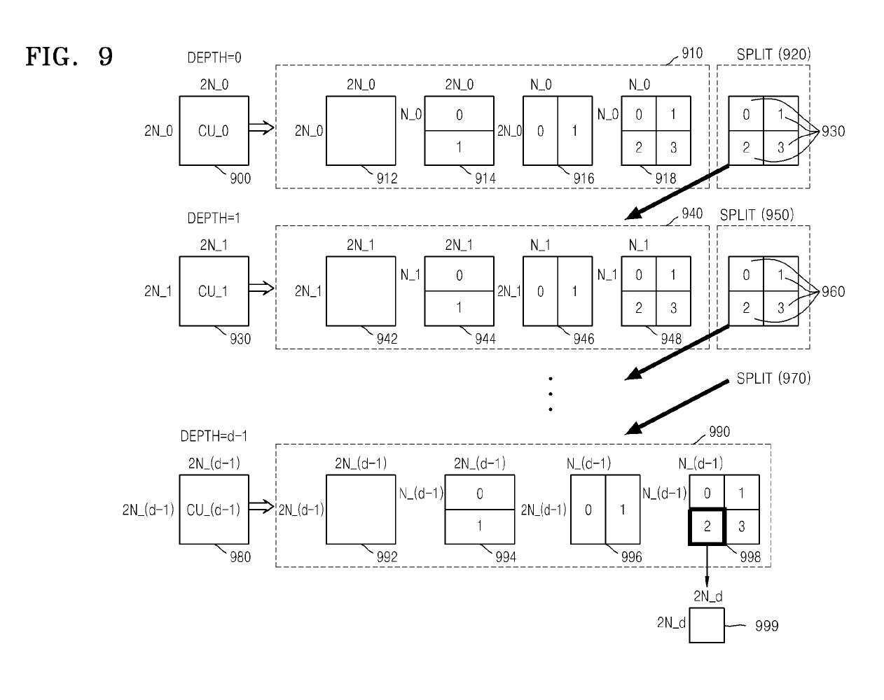

FIG. 9 is a diagram of deeper coding units according to depths according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode may be performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may not be further split to a lower depth.

If the encoding error is the smallest in the partition type 918 having the size of N_{—}0×N_{—}0, a depth may be changed from 0 to 1 to split the partition type 918 in operation 920, and encoding may be repeatedly performed on coding units 930 having a depth of 2 and a size of N_{—}0×N_{—}0 to search for the smallest encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth may be changed from 1 to 2 to split the partition type 948 in operation 950, and encoding may be repeatedly performed on coding units 960, which have a depth of 2 and a size of N_{—}2×N_{—}2 to search for the smallest encoding error.

When a maximum depth is d, split information according to each depth may be set until a depth becomes d−1, and split information may be set until a depth becomes d−2. In other words, when encoding is performed until the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having the smallest encoding error.

Even when the partition type 998 having the size of N_(d−1)×N_(d−1) has the smallest encoding error, because a maximum depth is d, a coding unit CU_(d−1) having a depth of d−1 may not be further split to a lower depth, a coded depth for a current maximum coding unit 900 may be determined to be d−1, and a partition type of the current maximum coding unit 900 may be determined to be N_(d−1)×N_(d−1). Also, because the maximum depth is d, split information for a coding unit 952 having a depth of d−1 is not set.

A data unit 999 may be referred to as a ‘minimum unit’ for the current maximum coding unit. A minimum unit may be a rectangular data unit obtained by splitting a minimum coding unit having a lowermost coded depth by 4. By performing the encoding repeatedly, the video encoding apparatus 100 may select a depth having a smallest encoding error by comparing encoding errors according to depths of the coding unit 900 to determine a coded depth, and may set a corresponding partition type and a prediction mode as an encoding mode of the coded depth.

As such, the smallest encoding errors according to depths are compared in all of the depths of 1 through d, and a depth having the smallest encoding error may be determined as a coded depth. The coded depth, the partition type of the prediction unit, and the prediction mode may be encoded and transmitted as information about an encoding mode. Also, because a coding unit has to be split from a depth of 0 to the coded depth, only split information of the coded depth has to be set to 0, and split information of depths excluding the coded depth has to be set to 1.

The image data and encoding information extractor 220 of the video decoding apparatus 200 may extract and use the information about the coded depth and the prediction unit of the coding unit 900 to decode the coding unit 912. The video decoding apparatus 200 may determine a depth, in which split information is 0, as a coded depth by using split information according to depths, and may use information about an encoding mode of the corresponding depth for decoding.

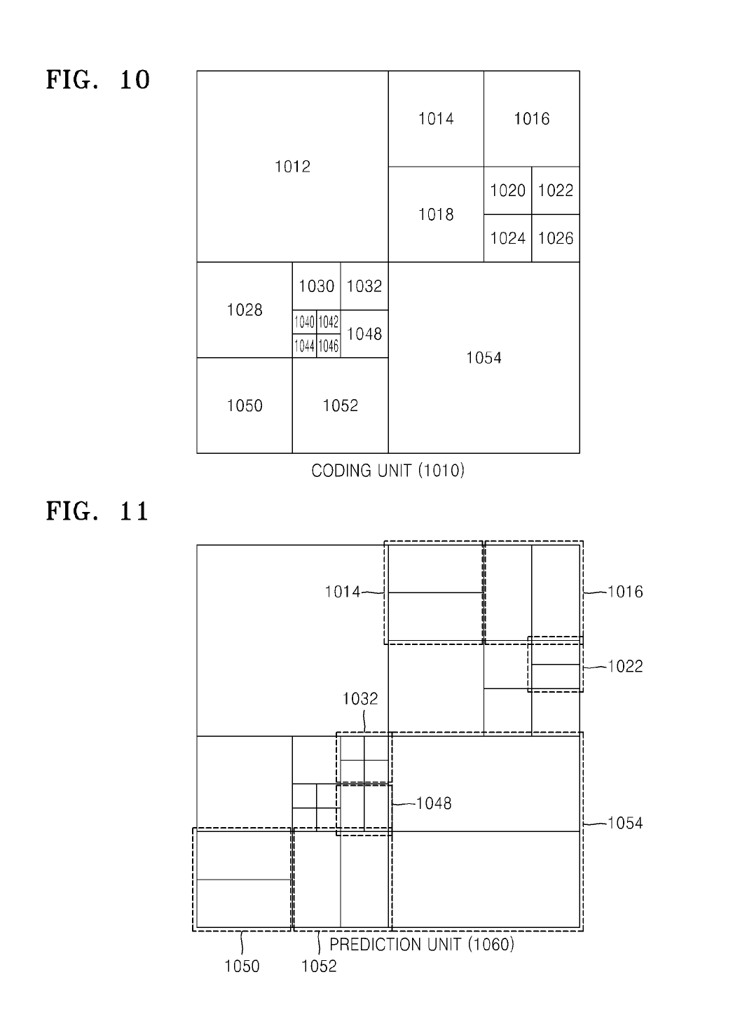

FIGS. 10 through 12 are diagrams for describing a relationship between coding units, prediction units, and frequency transformation units, according to an exemplary embodiment.

The coding units 1010 are coding units corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partition types in the partitions 1014, 1022, 1050, and 1054 have a size of 2N×N, partition types in the partitions 1016, 1048, and 1052 have a size of N×2N, and a partition type of the partition 1032 has a size of N×N. Prediction units and partitions of the coding units 1010 are smaller than or equal to each coding unit.

Frequency transformation or inverse frequency transformation is performed on image data of the transformation unit 1052 in the transformation units 1070 in a data unit that is smaller than the transformation unit 1052. Also, the transformation units 1014, 1016, 1022, 1032, 1048, 1050, and 1052 in the transformation units 1070 are different from those in the prediction units 1060 in terms of sizes or shapes. In other words, the video encoding apparatus 100 and the video decoding apparatus 200 may perform intra prediction/motion estimation/motion compensation, and frequency transformation/inverse frequency transformation individually on a data unit even in the same coding unit.

Accordingly, encoding may be recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 and the video decoding apparatus 200.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 may output the encoding information about the coding units having the tree structure, and the image data and encoding information extractor 220 of the video decoding apparatus 200 may extract the encoding information about the coding units having the tree structure from a received bitstream.

Split information indicates whether a current coding unit is split into coding units of a lower depth. If split information of a current depth d is 0, a depth, in which a current coding unit is no longer split to a lower depth, is a coded depth, and thus information about a partition type, a prediction mode, and a size of a transformation unit may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD are respectively obtained by splitting the height of the prediction unit in 1:3 and 3:1, and the asymmetrical partition types having the sizes of nL×2N and nR×2N are respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit is set to 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be set to N×N, and if the partition type of the current coding unit is an asymmetrical partition type, the size of the transformation unit may be set to N/2×N/2.

The encoding information about coding units having a tree structure may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth may be determined by using encoding information of a data unit, and thus a distribution of coded depths in a maximum coding unit may be determined.

Accordingly, if a current coding unit is predicted by referring to adjacent data units, encoding information of data units in deeper coding units adjacent to the current coding unit may be directly referred to and used.

Alternatively, if a current coding unit is prediction encoded by referring to adjacent data units, data units adjacent to the current coding unit in deeper coding units may be searched for by using encoded information of the data units, and the searched adjacent coding units may be referred to for prediction encoding the current coding unit.

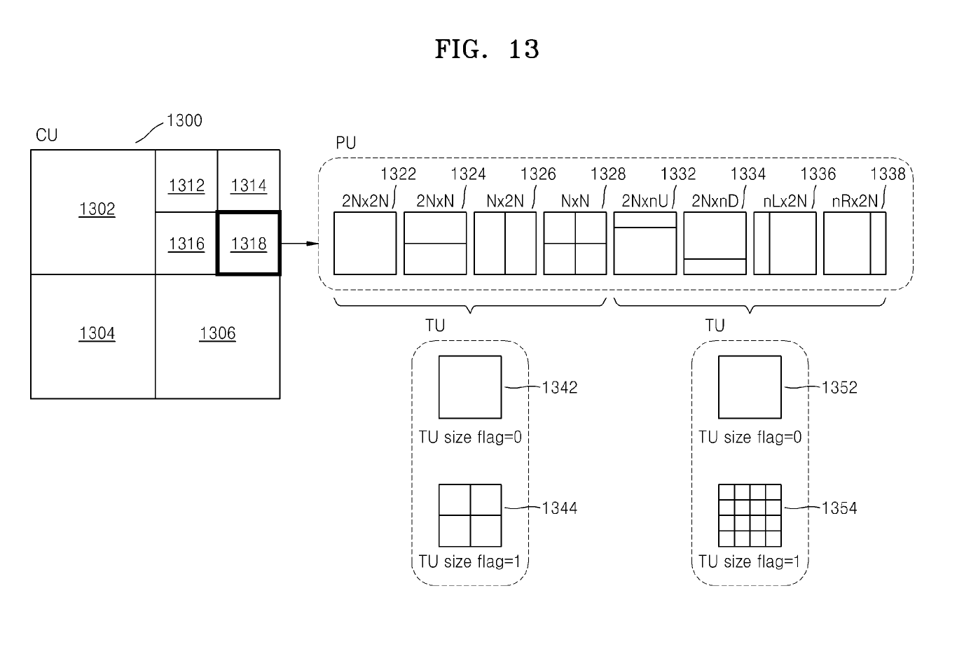

FIG. 13 is a diagram for describing a relationship between a coding unit, a prediction unit, and a transformation unit, according to the encoding mode information of Table 1.

A maximum coding unit 1300 includes coding units 1302, 1304, 1306, 1312, 1314, 1316, and 1318 of coded depths. Here, because the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322 having the size of 2N×2N, 1324 having the size of 2N×N, 1326 having the size of N×2N, or 1328 having the size of N×N, a transformation unit 1342 having a size of 2N×2N may be set if split information (TU size flag) of a transformation unit is 0, and a transformation unit 1344 having a size of N×N may be set if a TU size flag is 1.

When the partition type is set to be asymmetrical, i.e., the partition type 1332 having the size of 2N×nU, 1334 having the size of 2N×nD, 1336 having the size of nL×2N, or 1338 having the size of nR×2N, a transformation unit 1352 having a size of 2N×2N may be set if a TU size flag is 0, and a transformation unit 1354 having a size of N/2×N/2 may be set if a TU size flag is 1.

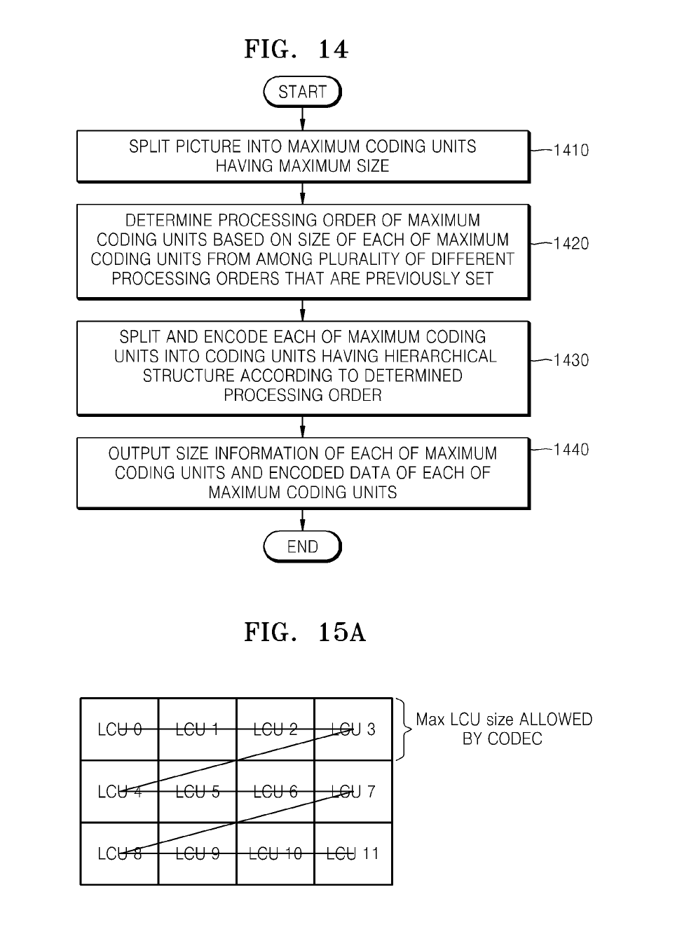

A method and apparatus for encoding a video, a method and apparatus for decoding a video, and video encoding and video decoding which change a scanning order according to hierarchical coding units according to embodiments of the present invention will now be explained with reference to FIGS. 14 through 25.

FIG. 14 is a flowchart illustrating a method of encoding a video, according to an exemplary embodiment.

Referring to FIGS. 1 and 14, in operation S1410, the maximum coding unit splitter 110 splits a picture into maximum coding units having a maximum size. The maximum coding unit splitter 110 selects one from among sizes of 64×64, 32×32, and 16×16, splits a picture into maximum coding units having the selected size, and outputs data of the obtained maximum coding units to the coding unit determiner 120. A size of each of the maximum coding units is not limited thereto, and may be any of various sizes. As described above, the video encoding apparatus 100 may split a picture into maximum coding units having various sizes, for example, maximum coding units having sizes of 64×64, 32×32, and 16×16 without using a block having a fixed size such as a macroblock, and may determine coding units having a hierarchical structure having a smallest encoding error for each of the maximum coding units. A size of each of the maximum coding units which is usable in the video encoding apparatus 100 may be previously set in the video encoding apparatus 100, may be set by a user, or may be set by a level/profile. The following will be described on the assumption that a size of each of the maximum coding units is one of 64×64, 32×32, and 16×16, and a coding unit having a maximum size that is usable in the video encoding apparatus 100 is a coding unit having a size of 64×64.

In operation S1420, the coding unit determiner 120 determines a processing order of the maximum coding units based on the size of each of the maximum coding units from among a plurality of different processing orders that are previously set. That is, the coding unit determiner 120 selects one from the processing orders that are previously set according to the size of each of the maximum coding units, and encodes the maximum coding units while scanning the maximum coding units according to the selected processing order.

For example, when the size of each of the maximum coding units is a maximum size that is usable in the video encoding apparatus 100, the unit determiner 120 may process the maximum coding units according to a raster scanning order. If the size of each of the maximum coding units input from the maximum coding unit splitter 110 is less than the maximum size that is usable in the video encoding apparatus 100, the coding unit determiner 120 assumes groups of maximum coding units having the maximum size that is usable in the video encoding apparatus 100 by combining adjacent maximum coding units, and processes the groups of maximum coding units according to the raster scanning order, wherein a processing order is determined such that maximum coding units in each of the groups are processed according to a processing order based on a zigzag scanning order earlier than maximum coding units included in another group with a lower priority. As such, the reason why a processing order differs according to the size of each of the maximum coding units is that for maximum coding units having relatively small sizes, a correlation between maximum coding units is enhanced by causing an upper maximum coding unit and a left maximum coding unit that are adjacent to a current coding unit to be processed at similar times.

According to the raster scanning order, at a point of time when a current maximum coding unit is scanned, a maximum coding unit that is located at the left or a maximum coding unit that is located at the top is processed whereas a maximum coding unit that is located at the right or the maximum coding unit that is located at the bottom is not yet processed. That is, according to the raster scanning order, because processing of the maximum coding unit that is located at the left and the maximum coding unit that is located at the top is already completed at the point of time when the current maximum coding unit is processed, data at the left and the top may be used as reference data. However, because the maximum coding unit that is located at the top of the current maximum coding unit is processed earlier than the point of time when the current coding unit is processed, encoded data of the maximum coding unit at the top at the point of time when the current maximum coding unit is processed is not stored in a memory that may be quickly accessed such as a cache but was stored in another memory area and then is re-loaded to the cache at the point of time when the current maximum coding unit is processed, thereby reducing a cache hit ratio. In other words, because maximum coding units are sequentially processed from the left to the right according to the raster scanning order, a maximum coding unit that is usable at a point of time when one maximum coding unit is processed is a left maximum coding unit that is processed right before, and an upper maximum coding unit was processed earlier than the point of time when the current maximum coding unit is processed and thus there is a high possibility that corresponding data is not stored in the cache. Accordingly, for maximum coding units having relatively small sizes and having a high possibility of correlation with neighboring information, a cache hit ratio may be increased by causing the maximum coding units to be processed at similar times to neighboring maximum coding units according to the zigzag scanning order.

In operation S1430, the coding unit determiner 120 encodes image data in deeper coding units according to depths for each maximum coding unit and selects a depth having a smallest encoding error as a coded depth. That is, as described with reference to FIGS. 1 through 13, the coding unit determiner 120 determines coding units having a hierarchical structure by encoding the image data in the deeper coding units according to depths for each maximum coding unit and selecting the depth having the smallest encoding error occurs as the coded depth, based on a depth indicating a number of times each of the maximum coding units is split. Also, the coding unit determiner 120 determines an optimum maximum coding unit having a size from among maximum coding units having various sizes, and determines a maximum coding unit having a smallest encoding error as a maximum coding unit that is finally used to split a current picture. For example, when a size of each of the maximum coding units is one of 64×64, 32×32, and 16×16 as described above, the coding unit determiner 120 may compare a first encoding error that is obtained when a picture is split by using a maximum coding unit having a size of 64×64 and coding units having a hierarchical structure are determined by splitting each of the maximum coding units, a second encoding error that is obtained when a picture is split by using a maximum coding unit having a size of 32×32 and coding units having a hierarchical structure are determined by splitting each of the maximum coding units, and a third encoding error that is obtained when a picture is split by using a maximum coding unit having a size of 16×16 and coding units having a hierarchical structure are determined by splitting each of the maximum coding units, and may determine a size of each of the maximum coding units having a smallest encoding error and coding units having a hierarchical structure.

As described above, the image data in each of the maximum coding units is encoded based on deeper coding units according to at least one depth equal to or less than a maximum depth, and encoding results based on the deeper coding units are compared. A depth having a smallest encoding error from among encoding errors of the deeper coding units may be selected. At least one coded depth may be determined for each maximum coding unit. Even when coding units correspond to the same depth included in one maximum coding unit, it is determined whether to split each of the coding units corresponding to the same depth to a lower depth by measuring an encoding error of the data, separately. Accordingly, although data is included in one maximum coding unit, because the encoding errors according to depths differ according to regions, the coded depth may differ according to the regions. Accordingly, one or more coded depths may be set for one maximum coding unit, and the data of the maximum coding unit may be divided according to coding units of the one or more coded depths. As such, the coding unit determiner 120 splits each of the maximum coding units into coding units having a hierarchical structure based on a coded depth, and performs prediction encoding and frequency transformation on each of the coding units. The coding unit determiner 120 finally determines the coding units having the hierarchical structure by determining a split type having a smallest encoding error from among various split types, and outputs encoded data of each of the coding units.

In operation S1440, the output unit 130 outputs size information of each of the maximum coding units and encoded data of each of the maximum coding units. The encoded data of the maximum coding units may include depth information for determining the coding units having the hierarchical structure, prediction mode information of each of the coding units, and residual information of the coding units.

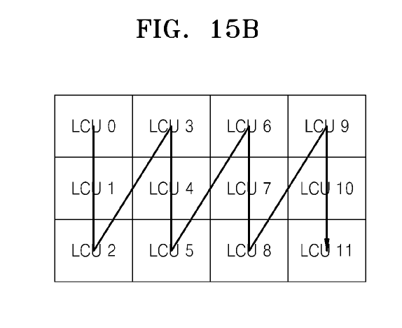

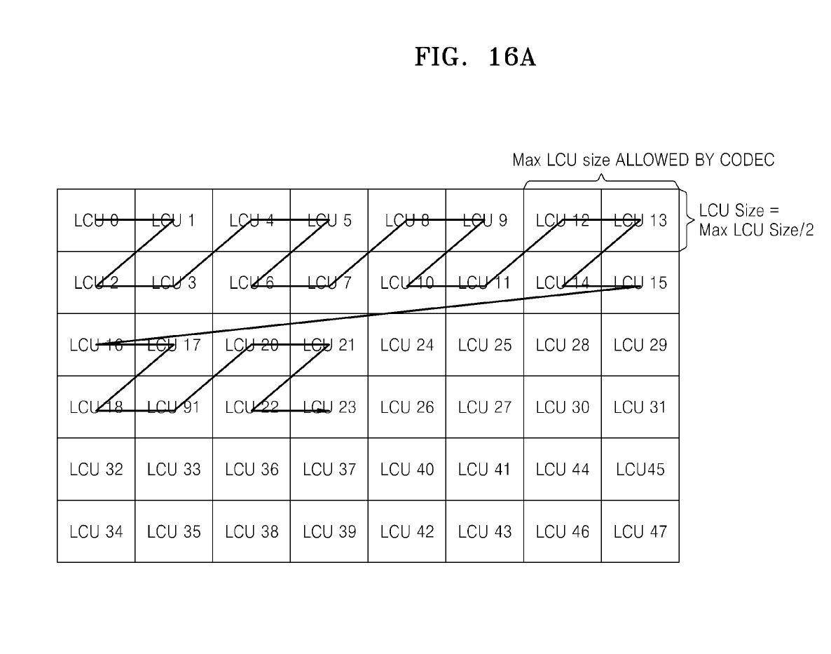

FIGS. 15A through 17 are diagrams for describing a processing order of maximum coding units according to a size of each of the maximum coding units, according to an exemplary embodiment. The largest coding unit (LCU) # of FIGS. 15A through 17 denotes a processing order of maximum coding units.

Referring to FIG. 15A, when a maximum coding unit LCU has a maximum size Max LCU Size that is allowed by a codec, each of maximum coding units is processed while being scanned from the left to the right and from the top to the bottom according to a raster scanning order. Also, referring to FIG. 15B, the raster scanning order according to an exemplary embodiment may be an order in which scanning and processing are performed from the top to the bottom and from the left to the right, in a vertical direction instead of a conventional horizontal direction.

As described above, assuming that a size of each of the maximum coding units is one of 64×64, 32×32, and 16×16, when a size of each of input maximum coding units is 64×64 and thus corresponds to a coding unit having a maximum size that is usable in the video encoding apparatus 100, the coding unit determiner 120 determines a processing order of the input maximum coding units as a raster scan processing order.

Referring to FIGS. 16A and 16B, when a maximum coding unit LCU has a size of 32×32 that is ½ of the maximum size Max LCU Size that is allowed by the codec, a group of adjacent maximum coding units, for example, 4 maximum coding units that are horizontally and vertically adjacent such as LCU0, LCU1, LCU2, and LCU3, is assumed and a plurality of the groups of the maximum coding units are processed according to a raster scanning order. As shown, the group of the maximum coding units LCU0, LCU1, LCU2, and LCU3 corresponds to the maximum size Max LCU Size that is allowed by the codec having a size of 64×64, processing of the maximum coding units LCU0, LCU1, LCU2, and LCU3 is completed and then a group of next maximum coding units LCU4, LCU5, LCU6, and LCU7 is processed. In other words, when the maximum coding unit LCU has a size that is ½ of the maximum coding unit Max LCU Size that is allowed by the codec, the coding unit determiner 120 forms a group corresponding to the maximum size Max LCU Size that is allowed by the codec by combining maximum coding units that are vertically and horizontally adjacent to one another, and determines a processing order such that a plurality of the groups are processed according to a raster scanning order. Next, the coding unit determiner 120 processes maximum coding units included in each group according to a zigzag scanning order as shown.

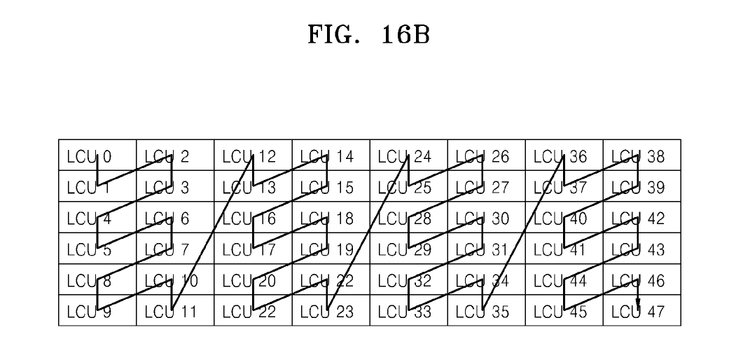

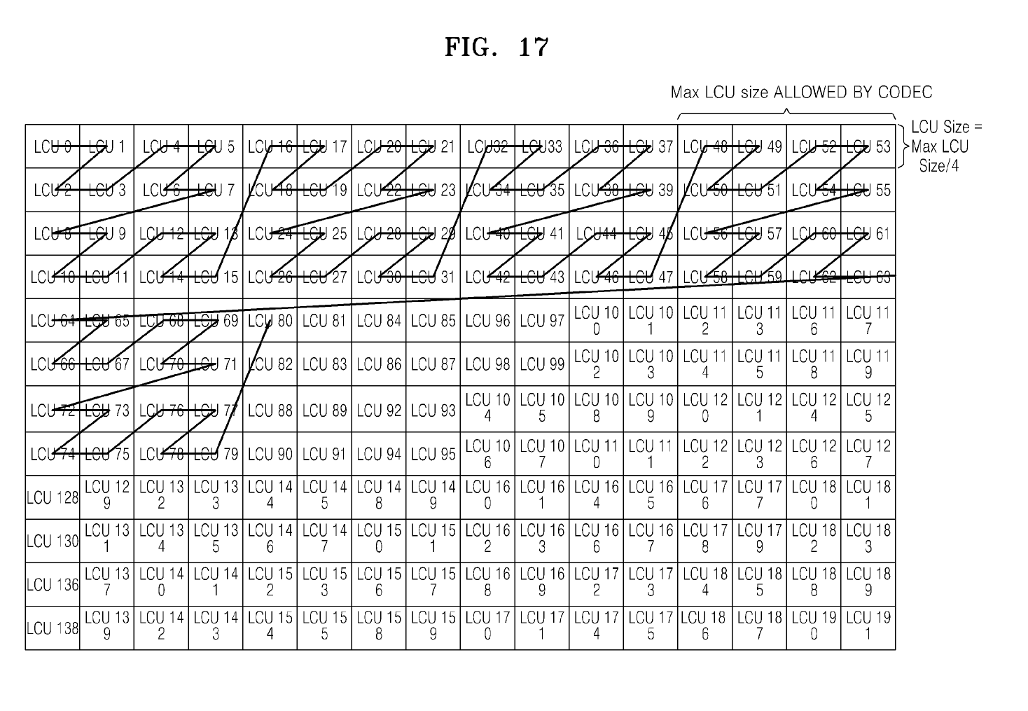

Referring to FIG. 17, when the maximum coding unit LCU has a size of 16×16 that is ¼ of the maximum size Max LCU Size that is allowed by the codec, a group of adjacent maximum coding units, for example, a group obtained by combining 16 maximum coding units such as LCU0 through LCU15 is assumed and a plurality of the groups of maximum coding units are processed according to a raster scanning order. As shown, the group of the maximum coding units LCU0 through LCU15 corresponds to the maximum size Max LCU Size that is allowed by the codec having a size of 64×64, and processing of the maximum coding units LCU0 through LCU15 is completed and then a group of next maximum coding units LCU16 through LCU31 is processed. In other words, when the maximum coding unit LCU has a size that is ¼ of the maximum size Max LCU Size that is allowed by the codec, the coding unit determiner 120 forms a group corresponding to the maximum size Max LCU Size that is allowed by the codec by combining adjacent maximum coding units, and determines a processing order such that a plurality of the groups are processed according to a raster scanning order. Next, the coding unit determiner 120 encodes maximum coding units included in each group according to a processing order based on a zigzag scanning order as shown. Like in FIGS. 15B and 16B, the raster scanning order may be an order in which scanning and processing are performed from the top to the bottom and from the left to the right, in a vertical direction instead of a conventional horizontal direction.

As such, according to an exemplary embodiment, maximum coding units are encoded according to different scanning orders according to sizes of the maximum coding units. In particular, for maximum coding units having relatively small sizes, because a processing order is determined such that the maximum coding units having the relatively small sizes are processed at similar times to neighboring maximum coding units, utilization of data that is spatially adjacent may be improved when the maximum coding unit having the relatively small sizes are processed. The raster scanning order and the zigzag scanning order are exemplary, and any of various scanning orders that are previously set may be determined according to a size of each maximum coding unit.

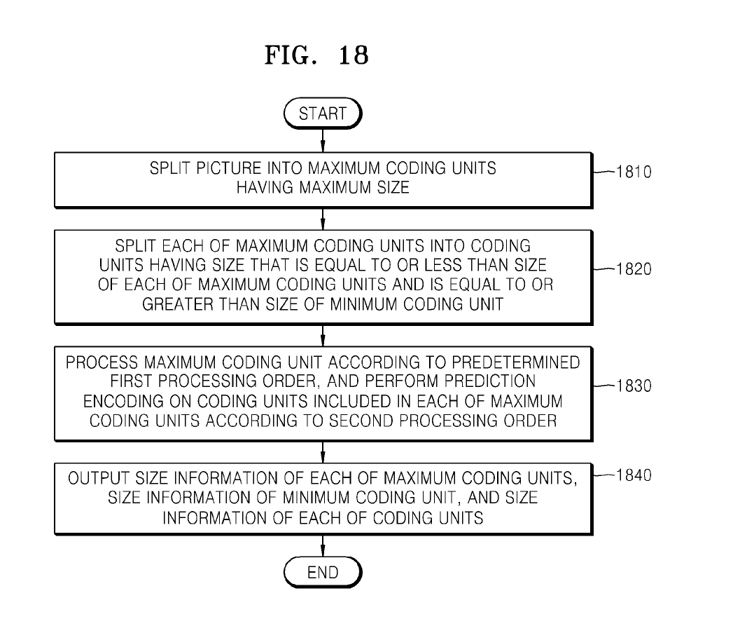

FIG. 18 is a flowchart illustrating a method of encoding a video, according to another embodiment of the present invention.

Referring to FIGS. 1 and 18, in operation S1810, the maximum coding unit splitter 110 splits a picture into maximum coding units having a maximum size. As described above, the maximum coding unit splitter 110 selects one size from among 64×64, 32×32, and 16×16, splits a picture into maximum coding units having the selected size, and outputs data of the obtained maximum coding units to the coding unit determiner 120.

In operation S1820, the coding unit determiner 120 splits each of the maximum coding units into coding units having a size that is equal to or less than a size of each of the maximum coding units and is equal to or greater than a size of a minimum coding unit. That is, when the size of each of the maximum coding units LCU size, the size of the minimum coding unit Min CU size, the size of each of the coding units CU size may be set to satisfy the following equation: Min CU size<=CU size<=LCU size. Accordingly, the maximum size Max CU size which each coding unit may have is equal to the size of the maximum coding unit LCU size. The size of each of the maximum coding units, the size of the minimum coding unit, and the size of each of the coding units may be previously set in the video encoding apparatus 100, may be set by a user, or may be set by a level/profile.

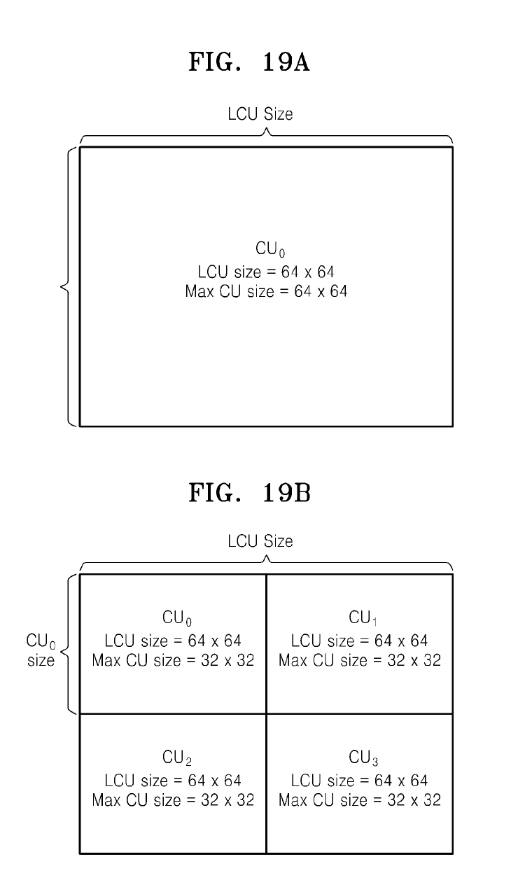

FIGS. 19A and 19B are diagrams for describing a relationship between a maximum coding unit and a coding unit, according to another exemplary embodiment.

As described above, when a size of a maximum coding unit is 64×64 and a size of a minimum coding unit is 16×16, a size of a coding unit may be set to be equal to or greater than 16×16 and to be equal to or less than 64×64. FIG. 19A illustrates that the maximum size Max CU size which the coding unit may have is set to 64×64 that is equal to the size of the maximum coding unit LCU size. Since the size of the coding unit CU refers to a maximum size of a data unit which becomes a basis for prediction and transformation, prediction and transformation may not be performed on a data unit having a size greater than the size of the coding unit CU. When the maximum size Max CU size which the coding unit may have is set to 64×64 that is equal to the size of the maximum coding unit LCU size, prediction and transformation may be performed by using a coding unit having a size that is equal to or less than 64×64 and is equal to or greater than the size of the minimum coding unit.

FIG. 19B illustrates that the maximum size Max CU Size which the coding unit may have is set to 32×32 that is ½ of the size of the maximum coding unit LCU size. As such, when the size of the maximum coding unit is set to 64×64 and the size of the coding unit is set to 32×32, prediction and transformation may be performed only on a data unit having a size that is equal to or less than a size of 32×32 and is equal to or greater than the size of the minimum coding unit, and prediction and transformation is not performed on a coding unit having a size greater than 32×32.

Referring back to FIG. 18, in operation S1830, the coding unit determiner 120 processes the maximum coding units according to a predetermined first processing order, and performs prediction encoding on the coding units included in each of the maximum coding units according to a second processing order that is different from the first processing order. For example, the coding unit determiner 120 may process the maximum coding units according to a raster scanning order, and may process the coding units included in each of the maximum coding units according to a zigzag scanning order independently from the raster scanning order.

In operation S1840, the output unit outputs size information of each of the maximum coding units, size information of the minimum coding unit, and size information of each of the coding units determined by the coding unit determiner 120.

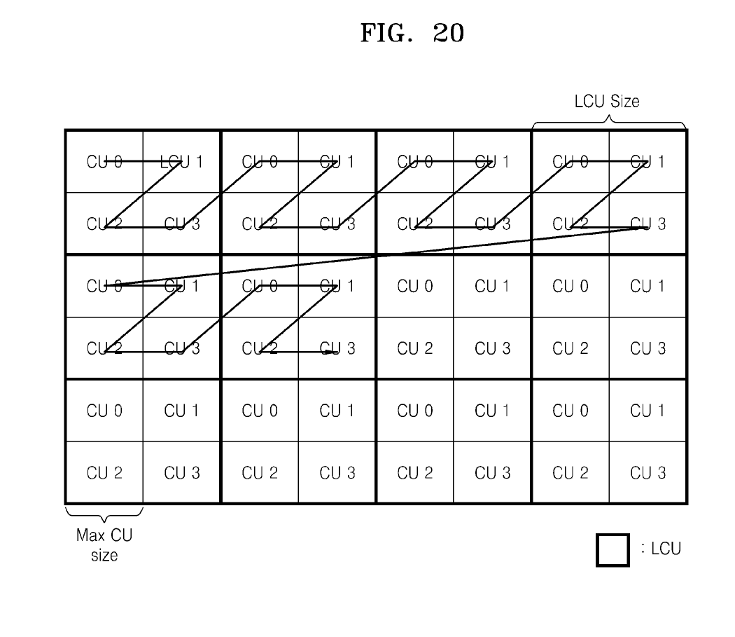

FIGS. 20 and 21 are diagrams for describing a processing order of maximum coding units and coding units included in each of the maximum coding units according to a size of each of the coding units split from each of the maximum coding units, according to an exemplary embodiment. # in CU # of FIGS. 20 and 21 denotes a processing order of coding units.

Referring to FIGS. 20 and 21, the maximum coding units LCU are processed according to a raster scanning order. Coding units included in each of the maximum coding units are processed based on a zigzag scanning order independently from the raster scanning order. In detail, referring to FIG. 20, when each maximum coding unit LCU is split into 4 coding units, coding units included in one maximum coding unit are processed according to a zigzag scanning order. When comparing FIGS. 15A-B and 20, when the maximum coding units LCU have a size of 64×64, the maximum coding units are processed according to a raster scanning order whereas coding units having a size of 32×32 split from one maximum coding unit are processed according to a zigzag scanning order. Likewise, referring to FIG. 21, when each maximum coding unit LCU is split into 16 coding units, coding units included in one maximum coding units are processed based on a zigzag scanning order. The raster scanning order and the zigzag scanning order are exemplary, and any of various scanning orders that are previously set may be used.

Meanwhile, when one maximum coding unit is split into coding units and the coding units are processed according to another exemplary embodiment, size information of each of the maximum coding units, size information of a minimum coding unit, and size information of each of the coding units have to be transmitted in order for a decoder to determine a size of each of the coding units.

The size information of each of the maximum coding units, the size information of the minimum coding unit, and the size information of each of the coding units may be included in a sequence parameter set (SPS) or a picture parameter set (PPS).

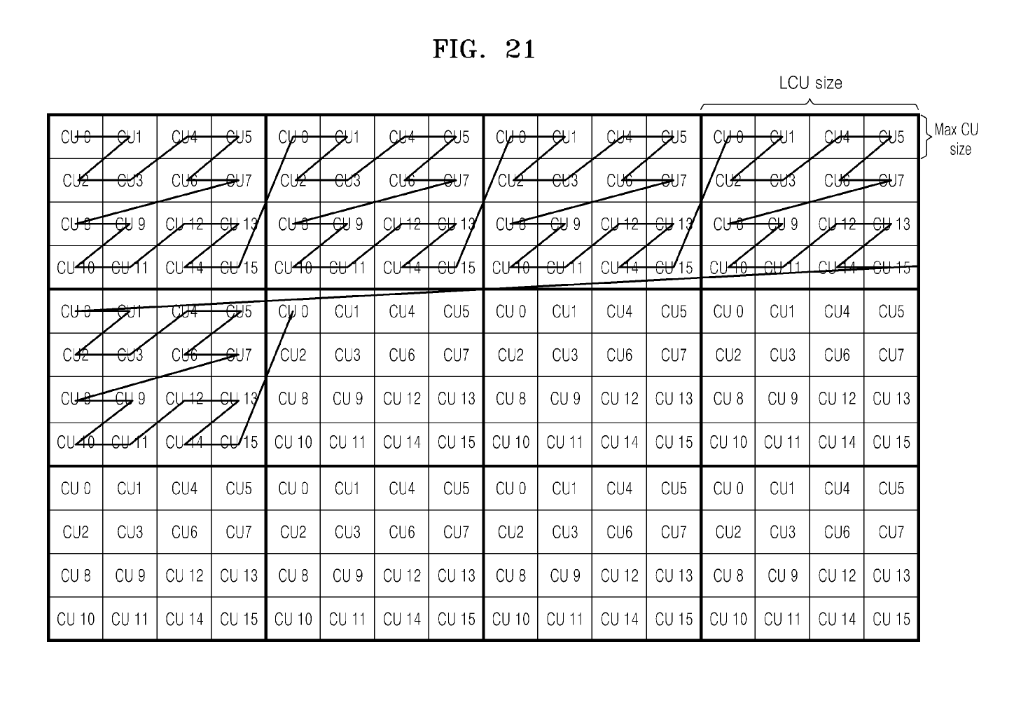

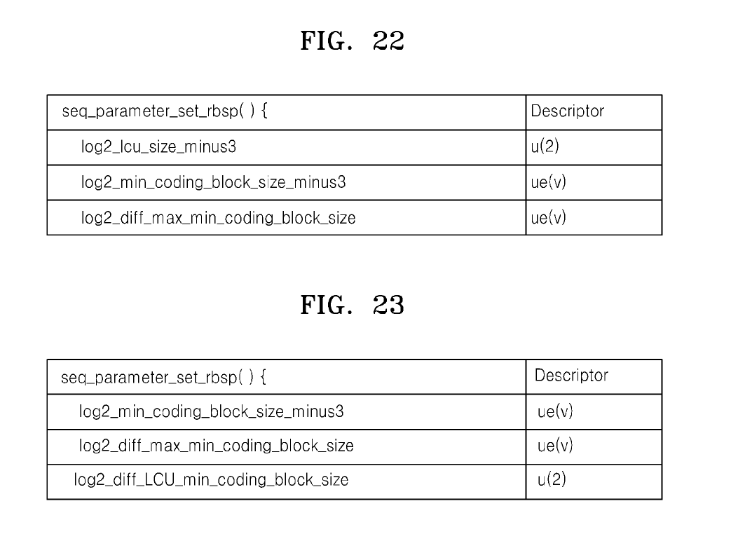

FIGS. 22 and 23 are diagrams illustrating size information of a maximum coding unit, size information of a minimum coding unit, and size information of a coding unit added to an SPS, according to another exemplary embodiment.

In order to reduce the amount of data to be encoded, an original value may be added to at least one from among the size information of the maximum coding unit, the size information of the minimum coding unit, and the size information of the coding unit, and only a difference value from the size information to which the original value is added may be transmitted to the remaining size information. For example, when a length of one axis of the maximum coding unit is lcu_size and a length of one axis of the minimum coding unit is min_coding_block_size, only a difference value from the length of one axis of the maximum coding units or the length of the one axis of the minimum coding unit may be transmitted for a length of one axis of the coding unit max_coding_block_size. Also, the amount of data may be reduced by not encoding the length of one axis indicating a size of each data unit itself but obtaining a log value and transmitting a value obtained by subtracting a predetermined integer, for example, 3, from the log value. For example, when the length of one axis of the maximum coding unit is 64, that is, 2̂ 6, log₂(2̂ 6)−3=3 is transmitted as size information of the maximum coding unit log 2_lcu_size_minus3. When the length of one axis of the minimum coding unit is 16, that is, 2̂ 4, log₂(2̂ 4)−3=1 is transmitted as size information of the minimum coding unit log 2_min_coding_block_size_minus3. As shown in FIG. 22, when a size of the coding units is 32×32, log₂(2̂5)−log₂(2̂4)=1 that is a difference value between 32, that is, 2̂ 5 that is the length of one axis of the coding unit and 2̂4 that is the length of one axis of the minimum coding unit is transmitted as size information of the coding unit log 2_diff_max_min_coding_block_size.

Also, referring to FIG. 23, the size information of the minimum coding unit log 2_min_coding_block_size_minus3 itself may be transmitted, and only a difference value from the size of the minimum coding unit may be transmitted for the size information of the maximum coding unit and the size information of the coding unit. For example, when the length of one axis of the minimum coding unit is 16, that is, 2̂4, log₂(2̂ 4)−3=1 is transmitted as the size information of the maximum coding unit log 2_min_coding_block_size_minus3. When the length of one axis of the maximum coding unit is 64, that is, 2̂ 6, log₂(2̂6)−log₂(2̂4)=2 is transmitted as the size information of the maximum coding unit log 2_diff_lcu_min_coding_block_size. When the length of one axis of the coding unit is 32, that is, 2̂ 5, log₂(2̂ 5)−log₂(2̂4)=1 is transmitted as the size information of the coding unit log 2_diff_max_min_coding_block_size.

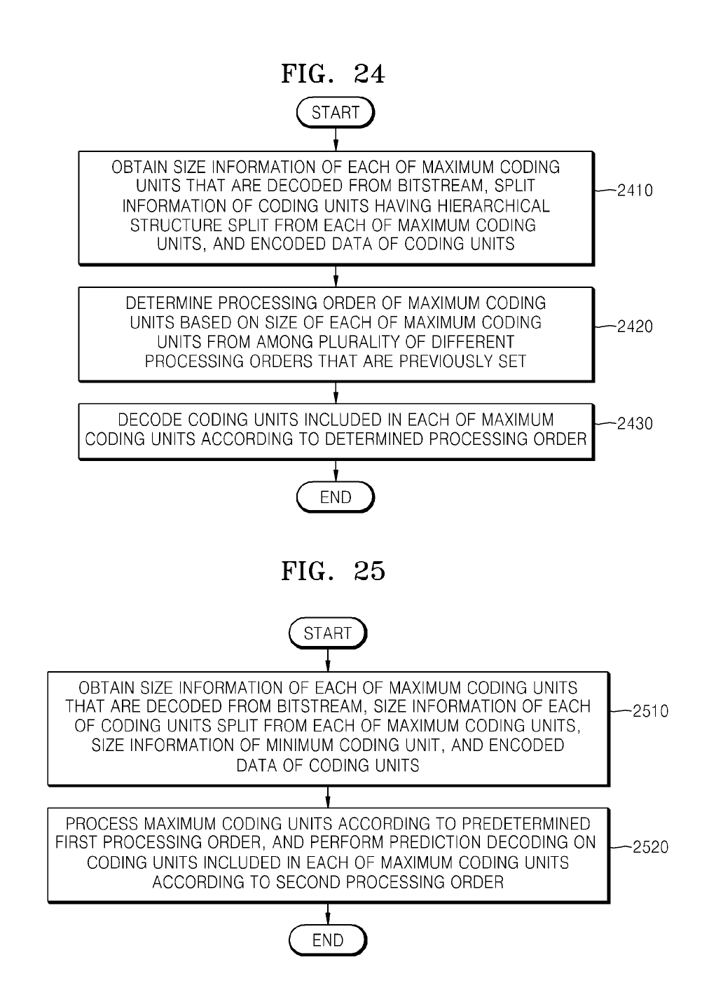

FIG. 24 is a flowchart illustrating a method of decoding a video, according to an exemplary embodiment.

Referring to FIGS. 2 and 24, in operation S2410, the image data and encoding information extractor 220 obtains size information of each of maximum coding units that are decoded from a parsed bitstream, split information of coding units having a hierarchical structure split from each of the maximum coding units, and encoded data of the coding units. The split information includes a coded depth determined by encoding image data in deeper coding units according to depths for each maximum coding unit and selecting a depth having a smallest encoding error based on a depth indicating a number of times each of the maximum coding units is split, and the image data decoder 230 may determine the coding units having the hierarchical structure split from each of the maximum coding units based on the split information.

In operation S2420, the image data decoder 230 determines a processing order of the maximum coding units based on a size of each of the maximum coding units from among a plurality of different processing orders that are previously set. When the size of each of the maximum coding units is a maximum size that is usable in the video decoding apparatus 200, the image data decoder 230 may process the maximum coding units according to a raster scanning order. If the size of each of the maximum coding units is less than the maximum size that is usable in the video decoding apparatus 200, the image data decoder 230 may assume a group of maximum coding units having the maximum size that is usable in the video decoding apparatus 200 by combining adjacent maximum coding units, and may process a plurality of the groups of the maximum coding units according to a raster scanning order such that maximum coding units in each of the groups are processed according to a processing order based on a zigzag scanning order earlier than maximum coding units included in another group.

In operation S2430, the image data decoder 230 decodes the coding units included in each of the maximum coding units according to the determined processing order.

FIG. 25 is a flowchart illustrating a method of decoding a video, according to another exemplary embodiment.

Referring to FIGS. 2 and 25, in operation S2510, the image data and encoding information extractor 220 obtains size information of each of maximum coding units that are decoded from a parsed bitstream, size information of each of coding units split from each of the maximum coding units, size information of a minimum coding unit, and encoded data of the coding units. As described above, for at least one of the size information of each of the maximum coding units, the size information of the minimum coding unit, and the size information of each of the coding units, an original value may be included in the bitstream, and for the remaining size information, only a difference value from the size information to which the original value is added may be included in the bitstream. The image data and encoding information extractor 220 may obtain the size information in which the original value is included, and may obtain the remaining size information by adding the transmitted difference value.

In operation S2520, the image data decoder 230 processes the maximum coding units according to a predetermined first processing order, and performs prediction decoding on the coding units included in each of the maximum coding units according to a second processing order that is different from the first processing order. For example, the image data decoder 230 may process the maximum coding units according to a raster scanning order, and may perform prediction decoding on the coding units included in each of the maximum coding units according to a zigzag scanning order independently from the raster scanning order.

The exemplary embodiments may be written as computer programs and may be implemented in general-use digital computers that execute the programs by using a computer-readable recording medium. Examples of the computer-readable recording medium include magnetic storage media (e.g., a read-only memory (ROM), a floppy disc, and a hard disc), optically readable media (e.g., a compact disc-read only memory (CD-ROM) and a digital versatile disc (DVD)), and carrier waves (such as data transmission through the Internet).

While the exemplary embodiments have been particularly shown and described, it will be understood by those of ordinary skill in the art that various changes in form and details may be made therein without departing from the spirit and scope of the application as defined by the appended claims. The exemplary embodiments should be considered in a descriptive sense only and not for purposes of limitation. Therefore, the scope of the application is defined not by the detailed description of the invention but by the appended claims, and all differences within the scope will be construed as being included in the present application.

1. A method of encoding a video, the method comprising:
splitting a picture into maximum coding units having a maximum size;
determining a processing order of the maximum coding units from among a plurality of different processing orders, based on a size of the maximum coding units;
splitting each of the maximum coding units into coding units having a hierarchical structure according to the determined processing order and encoding the coding units; and
outputting size information of each of the maximum coding units and outputting encoded data of each of the maximum coding units.

2. The method of claim 1, wherein the determining comprises:
when the size of each of the maximum coding units is a maximum size, determining the processing order of the maximum coding units as a raster scanning order, and
when the size of each of the maximum coding units is less than the maximum size, for groups obtained by combining the maximum coding units to have the maximum size, determining a processing order of the groups according to the raster scanning order, and for maximum coding units in each of the groups, determining a processing order of the maximum coding units in each of the groups such that the maximum coding units in a group are processed according to a zigzag scanning order earlier than maximum coding units included in another group with a lower priority.

3. The method of claim 1, wherein the encoding comprises determining the coding units having the hierarchical structure by encoding image data in deeper coding units according to depths for each maximum coding unit based on a depth indicating a number of times each of the maximum coding units are split and selecting a depth having a smallest encoding error as a coded depth.

4. A method of encoding a video, the method comprising:
splitting a picture into maximum coding units having a maximum size;
splitting each of the maximum coding units into coding units having a size that is equal to or less than a size of the maximum coding units and equal to or greater than a size of a minimum coding unit;
processing the maximum coding units according to a first processing order, and performing prediction encoding on the coding units split from the maximum coding units according to a second processing order that is different from the first processing order; and
outputting size information of each of the maximum coding units, size information of the minimum coding unit, and size information of each of the coding units.

5. The method of claim 4, wherein the first processing order for processing the maximum coding units is a raster scanning order, and the second processing order for processing the coding units is a processing order based on a zigzag scanning order.

6. An apparatus for encoding a video, the apparatus comprising:
a maximum coding unit splitter that splits a picture into maximum coding units having a maximum size;
a coded depth determiner that determines a processing order of the maximum coding units from among a plurality of different processing orders based on a size of the maximum coding units, splits each of the maximum coding units into coding units having a hierarchical structure according to the determined processing order, and encodes the coding units; and
an output unit that outputs size information of each of the maximum coding units and encoded data of each of the maximum coding units.

7. An apparatus for encoding a video, the apparatus comprising:
a maximum coding unit splitter that splits a picture into maximum coding units having a maximum size;
a coded depth determiner that splits each of the maximum coding units into coding units having a size that is equal to or less than a size of the maximum coding units and equal to or greater than a size of a minimum coding unit, processes the maximum coding units according to a first processing order, and performs prediction encoding on the coding units split from the maximum coding units according to a second processing order that is different from the first processing order; and
an output unit that outputs size information of each of the maximum coding units, size information of the minimum coding unit, and size information of each of the coding units.

8. A method of decoding a video, the method comprising:
obtaining size information of each of maximum coding units that are decoded from a bitstream, split information of coding units having a hierarchical structure split from the maximum coding units, and encoded data of the coding units;
determining a processing order of the maximum coding units from among a plurality of different processing orders based on a size of the maximum coding units; and
decoding the coding units that are split from the maximum coding units according to the determined processing order.

9. The method of claim 8, wherein the determining comprises:
when the size of each of the maximum coding units is a maximum size, determining the processing order of the maximum coding units as a raster scanning order,
when the size of each of the maximum coding units is less than the maximum size, for groups obtained by combining the maximum coding units to have the maximum size, determining a processing order of the groups according to the raster scanning order, and for maximum coding units in each of the groups, determining a processing order of the maximum coding units in each of the groups such that the maximum coding units in a group are processed according to a zigzag scanning order earlier than maximum coding units included in another group with a lower priority.

10. The method of claim 8, wherein the split information comprises a coded depth that is determined by encoding image data in deeper coding units according to depths for each maximum coding unit based on a depth indicating a number of times each of the maximum coding units are split and selecting a depth having a smallest encoding error,
wherein the obtaining of the encoded data of the coding units comprises determining the coding units having the hierarchical structure based on the coded depth.

11. A method of decoding a video, the method comprising:
obtaining size information of each of maximum coding units that are decoded from a bitstream, size information of each of coding units split from the maximum coding units, size information of a minimum coding unit, and encoded data of the coding units; and
processing the maximum coding units according to a first processing order, and performing prediction decoding on the coding units included in each of the maximum coding units according to a second processing order that is different from the first processing order.

12. The method of claim 11, wherein the first processing order for processing the maximum coding units is a raster scanning order, and the second processing order for processing the coding units included in each of the maximum coding units is a processing order based on a zigzag scanning order.

13. The method of claim 11, wherein the obtaining comprises, from among the size information of each of the maximum coding units, the size information of the minimum coding unit, and the size information of each of the coding units, obtaining an original value for two size information, and obtaining only a difference value from any one of the two size information to which the original value is added for the remaining size information.

14. An apparatus for decoding a video, the apparatus comprising:
an extractor that obtains size information of each of maximum coding units that are decoded from a bitstream, split information of coding units having a hierarchical structure split from the maximum coding units, and encoded data of the coding units; and
an image data decoder that determines a processing order of the maximum coding units from among a plurality of different processing orders based on a size of the maximum coding units, and decodes the coding units split from the maximum coding units according to the determined processing order.

15. An apparatus for decoding a video, the apparatus comprising:
an extractor that obtains size information of each of maximum coding units that are decoded from a bitstream, size information of coding units split from each of the maximum coding units, size information of a minimum coding unit, and encoded data of the coding units; and
an image data decoder that processes the maximum coding units according to a first processing order, and performs prediction decoding on the coding units included in each of the maximum coding units according to a second processing order that is different from the first processing order.
